(19) United States
(12) Patent Application Publication
(10) Pub. No.: US 2021/0094482 A1
(43) Pub. Date: Apr. 1, 2021

(54) HEADLINER FOR VEHICLE FOR REDUCING HEAD INJURY OF BACKSEAT OCCUPANT

(71) Applicant: DAEHAN SOLUTION CO., LTD., Incheon (KR)

(72) Inventors: Choong Ho KWON, Seoul (KR); Hyong-Jin KO, Incheon (KR)

(73) Assignee: DAEHAN SOLUTION CO., LTD., Incheon (KR)

(21) Appl. No.: 16/725,014

(22) Filed: Dec. 23, 2019

(30) Foreign Application Priority Data
Sep. 30, 2019 (KR) 10-2019-0121119

(51) Int. Cl. B60R 13/02

(52) U.S. Cl. CPC B60R 13/0212

(57) ABSTRACT

Since a rear edge of a headliner is set as a daylight opening (DLO) uppermost endpoint, a rear header point (RHP) is pushed backward from an existing position. Accordingly, since a space in which a jaw is rotatable when an occupant of a backseat collides with the headliner is secured, a Head Injury Criterion value is decreased such that a level of a head injury may be reduced. Particularly, when a distance between the DLO uppermost endpoint and the RHP is greater than or equal to 112 mm, the RHP is set a point 112 mm from the DLO uppermost endpoint, setting an angle between an XY-plane passing the DLO uppermost endpoint and the RHP to be present within a range of 0.5 to 10°, or setting a height difference in a Z-axis direction from the XY-plane as being in a range of 1 to 10 mm.

### CROSS-REFERENCE TO RELATED APPLICATION

This application claims priority to and the benefit of Korean Patent Application No. 10-2019-0121119, filed on Sep. 30, 2019, the disclosure of which is incorporated herein by reference in its entirety.

### BACKGROUND

### 1. Field of the Invention

The present invention relates to a headliner for a vehicle, and more particularly, to a headliner for a vehicle capable of further reducing a head injury of an occupant in which a daylight opening (DLO) uppermost endpoint (PT18) is set as a rear edge of the headliner such that a rear header point RH is set to be located behind an existing position in the middle between an upper roof (UR) intersectional point (PT17) and the DLO uppermost endpoint (PT18) so as to secure a space in which an occupant's jaw is rotatable between an occupant's head part and a headliner.

### 2. Discussion of Related Art

Generally, it is necessary for vehicles exported to North America to satisfy Federal Motor Vehicle Safety Standard (FMVSS) 201U which is a regulation for protecting occupants. According to this regulation, it is necessary to satisfy a head injury criterion (HIC(d))≤1,000 so as to prevent a serious injury or death when an occupant secondarily collides with interior materials of a vehicle due to a car accident and the like. Accordingly, to satisfy this regulation, an auxiliary shock-absorption material is mounted in a headliner which is one of such interior materials to be located between a roof panel and the headliner as in the following Patent Documents 1 to 3.

Patent Document 1: Korean Patent Registration No. 10-1546922

An aspect of the patent is to provide an auxiliary member for absorbing shock in a head lining of a vehicle, in which a corrugation member having corrugated portions continuously formed to extend in a transverse direction of the vehicle is installed between the head lining and a roof panel, and particularly, each of the corrugated portions may be divided into various areas according to a distance between the head lining and the roof panel, and a width of each area may be selected from various widths set according to head injury criterion (HIC(d)) based on a height of each area such that the areas may have different widths even when having the same height, and thus which may be designed to satisfy optimal conditions without interference between the roof panel and the head lining and without degradation of shock absorbing performance even though the distance between the roof panel and the head lining is changed by a reinforcing member (or panel) or the like installed inside the roof panel. Another aspect is to provide an auxiliary member for absorbing shock in a head lining of a vehicle, which may measure an injury value according to the HIC(d) in advance so as to satisfy the HIC(d) required in the auxiliary member while changing each of the corrugated portions of the corrugation member by the predetermined height and width and thus may be selectively designed from the various preset widths to satisfy the HIC(d) according to the heights of the corrugated portions and thus may be easily designed to provide the optimal shock absorbing performance

Patent Document 2: Korean Patent Publication No. 10-2018-0049833

A mounting hole is formed in one side to be fixed with an auxiliary handle and a plate is manufactured on another side to extend along a head lining plane to an edge thereof such that the plate may be easily manufactured and easily deformed by a shock applied by a head part such as a forehead or a jaw to absorb the shock and increase safety. Particularly, several ribs having a predetermined thickness and height are manufactured on a body at preset intervals such that ribs having a size appropriate for different shock absorbing performance required according to types of vehicles may be manufactured and used. Also, since this plate is manufactured using an injection molding method, even when a structure thereof is complicated, the plate may be easily and conveniently manufactured and used at a low price.

Patent Document 3: Korean Patent Publication No. 10-2018-0138219

Since a headliner is configured to reduce a level of an injury which may occur when a driver and an occupant's head part collides with the headliner using an airbag, the headliner may be easily manufactured and conveniently used due to a simple structure thereof. Particularly, since the headliner is configured such that the airbag is mounted between a roof panel and the headliner and is deployed while pushing an interior side, that is, the headliner, toward the inside, a size of a space in which the airbag is mounted may be minimized so as to easily secure an installation space and the airbag may be conveniently mounted. Also, since a part of the headliner which is folded when the airbag is deployed toward the headliner is configured to be easily broken or deformed by an deploying pressure of the airbag, when the airbag is deployed due to a collision or rear-end collision of a vehicle, the airbag may be quickly deployed so as to increase a shock absorbing effect.

Meanwhile, in a headliner that is one of interior materials, as shown in FIGS. 1 and 2, since a rear header point RH′ set as a middle point which connects an upper roof (UR) intersection point PT17 and a daylight opening uppermost endpoint PT18′ is closer to a hip point SgRP, when an accident occurs, an occupant of a backseat may receive a greater shock and be seriously injured. Here, the UR intersection point PT17, the DLO uppermost endpoint PT18′, the rear header point RH′, and the hip point SgRP are points defined in advance according to regulations and will be described below in detail.

### Related Art Documents

### Patent Documents

Patent Document 1: Korean Patent Registration No. 10-1546922 (Aug. 18, 2015)

Patent Document 2: Korean Patent Publication No. 10-2018-0049833 (May 14, 2018)

Patent Document 3: Korean Patent Publication No. 10-2018-0138219 (Dec. 31, 2018)

### SUMMARY OF THE INVENTION

The present invention is directed to providing a headliner for a vehicle that allows for reducing a level of a head injury by decreasing a head injury criterion (HIC(d)) value applied to a head part securing a space in which a jaw is rotatable when an occupant of a backseat collides with the headliner. Here, a daylight opening (DLO) uppermost endpoint PT18 is set as a rear edge of the headliner such that a rear header point RH is pushed backward from an existing position at a central position between the DLO uppermost endpoint PT18 and an upper roof (UR) intersection point PT17 determined as a line dividing an upper roof.

According to Federal Motor Vehicle Safety Standard (FMWVSS) 201U, when a distance between the DLO uppermost endpoint PT18 and the rear header point RH is greater than or equal to 112 mm, a point 112 mm from the DLO uppermost point PT18 is set as the rear header point RH. The present invention is also directed to providing a headliner for a vehicle that is capable of reducing a level of head injury by securing a space in which a jaw is rotatable by setting the uppermost endpoint PT18 at a rear edge of the headliner.

The present invention is also directed to providing a headliner for a vehicle that is capable of reducing a level of a head injury by securing a space in which a jaw is rotatable by manufacturing such that an angle θ formed by an XY-plane passing a DLO uppermost point PT18 and a rear header point RH is present within a range of 0.5 to 10° or a height difference H from the XY-plane in a Z-axis direction is in a range of 1 to 10 mm.

According to an aspect of the present invention, there is provided a headliner for a vehicle that is capable of reducing a head injury of an occupant of a backseat. Here, a proceeding direction of the vehicle is set as an X-axis direction, a width direction of the vehicle is set as a Y-axis direction, and a height direction of the vehicle is set as a Z-axis direction. Here, (1) a hip point (SgRP) that is a reference point of the backseat is set as P28, (2) an upper roof (UR) intersection point intersecting a divisional line A dividing an upper roof in a headliner plane P cut by an XZ-plane Xp passing the hip point (SgRP P28) is set as PT17, (3) a rear edge part of the headliner plane P is set as PT18 which is a daylight opening (DLO) uppermost endpoint, (4) a central point of a length which connects the UR intersection point PT17 and the DLO uppermost endpoint PT18 in the headliner plane P is set as a rear header point RH, and the rear header point RH is set as a point 112 mm from the DLO uppermost endpoint PT18 when a distance between the DLO uppermost endpoint PT18 and the rear header point RH is greater than or equal to 112 mm Also, an angle θ between an XY-plane passing the DLO uppermost endpoint PT18 and the rear header point RH is in a range of 0.5 to 10° or a height difference H on the basis of the XY-plane is in a range of 1 to 10 mm in a Z-axis direction.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a plan view illustrating a headliner in a conventional method of setting a position of a rear header point RH′;

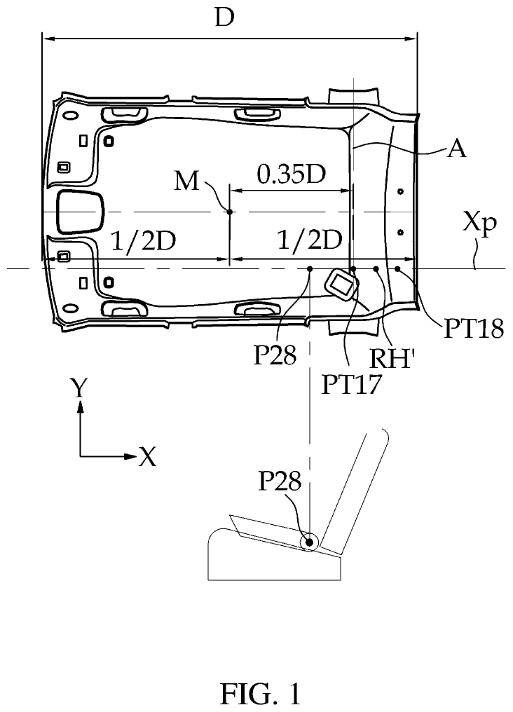

FIG. 2 is an enlarged cross-sectional view illustrating a conventional headliner rear part enlarged to illustrate positions of an upper roof (UR) intersection point, a daylight opening (DLO) uppermost endpoint PT18′, and the header point RH′;

FIG. 3 is a partial cross-sectional view of a conventional headliner which illustrates a movement direction of a dummy when the dummy applies a shock to the headliner;

FIG. 4 is a plan view illustrating a headliner in a method of setting a position of a rear header point RH according to one embodiment of the present invention;

FIG. 5 is an enlarged cross-sectional view illustrating a headliner rear part enlarged to illustrate positions of a UR intersection point, a DLO uppermost endpoint PT18, and the header point RH according to one embodiment of the present invention;

FIG. 6 is a partial cross-sectional view of the headliner according to one embodiment of the present invention and which illustrates a movement direction of a dummy when the dummy applies a shock to the headliner; and

FIG. 7 is a graph illustrating resultant changes in deceleration of changing in time of a conventional headliner to which a rear header point is applied (a comparative example) and the headliner to which a rear header point according to one embodiment of the present invention is applied (an embodiment).

FIG. 8 is a comparison of the result of deceleration according to a time change with respect to the headliner according to the present invention with an existing headliner for a vehicle (comparative example).

### DETAILED DESCRIPTION OF THE INVENTION

Hereinafter, an exemplary embodiment of the present invention will be described in detail with reference to the attached drawings. In advance, the terms used in the specification and the claims should not be limited to general or lexical meanings and should be interpreted as meanings and concepts coinciding with the technical concept of the present invention on the basis of a principle in which the inventor can appropriately define the concept of the terms to describe the invention in the best manner

Accordingly, since the embodiment disclosed in the specification and components shown in the drawings are merely a most exemplary embodiment of the present invention and do not represent an entirety of the technical concept of the present invention, it should be understood that a variety of equivalents and modifications capable of substituting the embodiments and the components may be present at the time of filing of the present application.

(Components)

A headliner for a vehicle for reducing a head injury of a back-seat occupant according to one embodiment of the present invention is manufactured such that a daylight opening (DLO) uppermost endpoint PT18 is a part of a rear edge of the headliner, a rear header point RH set at a position in the middle between the DLO uppermost endpoint PT18 and an upper roof (UR) intersectional point PT17 is located behind the headliner such that a space is provided in which an occupant's jaw is rotatable to reduce a head injury of the occupant when an occupant's head part collides with the headliner.

Particularly, when a distance from the DLO uppermost endpoint PT18 is greater than or equal to 112 mm, the rear header point RH is set at a point spaced 112 mm from the DLO uppermost endpoint PT18 such that the rear header point RH may be prevented from moving in front of the headliner more than a certain degree and a space adequate for the jaw to be rotatable may be secured.

Also, since an angle θ formed between the DLO uppermost endpoint PT18 and the rear header point RH on the basis of an XY-plane which passes the DLO uppermost endpoint is to be in a range of 0.5 to 10°, or a height difference H in a Z-axis direction is to be in a range of 1 to 10 mm, an adequate space may be provided between the occupant's head part and the headliner so as to minimize an injury occurring when the head collides with the headliner.

Hereinafter, the above components will be described in detail with reference to the attached drawings. Here, prior to describing settings according to the present invention, XYZ-axes, a hip point SgRP, the UR intersection point PT17, the DLO uppermost endpoint PT18, and the rear header point RH will be defined with describing the settings.

A. XYZ-Axes

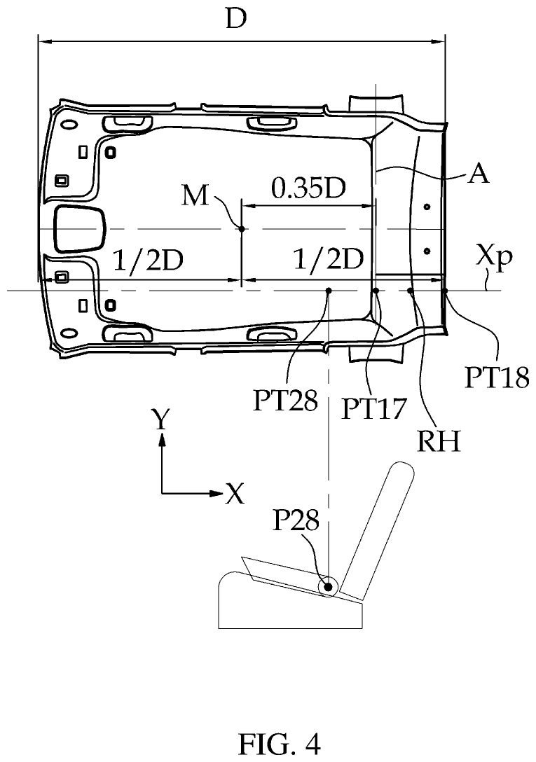

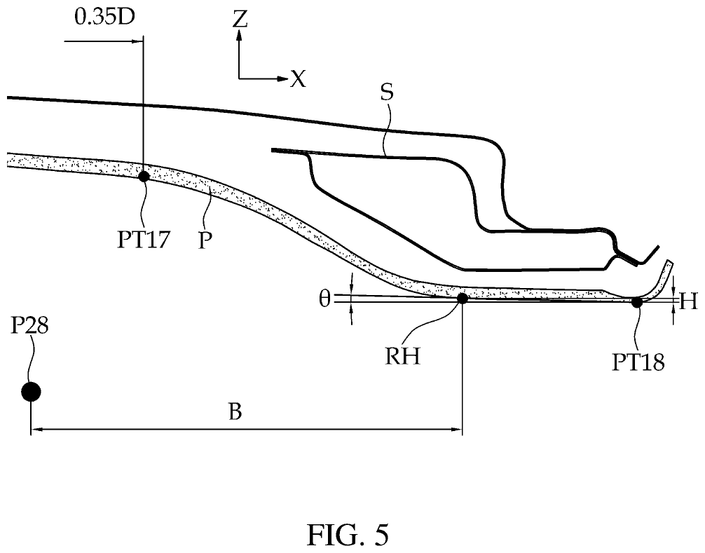

In XYZ-axes, as shown in FIGS. 4 and 5, an X axis indicates a proceeding direction of a vehicle, a Y-axis indicates a width direction of the vehicle, and a Z-axis indicates a height direction of the vehicle. Also, it may be easily known to one of ordinary skill in the art that two axes among the axes may form one plane such as an XY-plane, an XZ-plane, and the like.

B. Hip Point SgRP

As shown in FIGS. 4 and 5, a hip point SgRP P28 is a point corresponding to a hip point of a person when he or she takes a seat. The hip point is referred to as an “H” point or a “seating reference point” and has been defined in a test procedure (TP-201U-02) of Federal Motor Vehicle Safety Standard (FMVSS) No. 201U.

C. UR Intersection Point

The UR intersection point PT17 indicates an intersection point between the XZ-plane Xp and a divisional line A as shown in FIGS. 4 and 5. Here, the XZ-plane Xp refers to a plane formed of the X-axis and the Z-axis that passes through the hip point P28. Also, when a length of the headliner is D, the divisional line A is a line forming a section along a YZ-plane that passes a point moved behind the headliner by 0.35 D on the basis of a reference point M that is ½ D from both edges of the headliner. The divisional line A has been defined in the test condition procedure TP-201U-02 of FMVSS No. 201U.

That is, as shown in FIGS. 4 and 5, the UR intersection point PT17 indicates an intersection point, which is a point moved from an edge of the headliner by the divisional line A, in a headliner plane P cut by the XZ-plane Xp.

D. DLO uppermost endpoint

According to the test condition procedure TP-201U-02 of FMVSS No. 201U, DLO means a point which comes into contact with the headliner plane P at a lowermost position when the XY-plane is moved in a Z-axis direction. The point may be one point or two or more points. When two or more points are present, the point means an innermost point.

Meanwhile, as shown in FIGS. 4 and 5, according to the present invention, a point at a position having a lowest Z value among DLOs defined as described above is set as the DLO uppermost endpoint PT18, and the DLO uppermost endpoint PT18 is to be located at a rear edge part of the headliner plane P.

E. Rear Header Point

The rear header point RH is set at a middle position in a length which connects the UR intersection point PT17 and the DLO uppermost endpoint PT18 along the above-described headliner plane P as shown in FIGS. 4 and 5. Here, a rear header is a material installed on a roof panel of the vehicle in a Y-axis direction and has a width cross section having an approximately upside-down right triangle shape to be installed such that an inclined plane faces an inside of the vehicle.

As described above, according to the present invention, since the DLO uppermost endpoint PT18 is set at the rear edge part of the headliner plane P, a distance between the UR intersection point PT17 and the DLO uppermost endpoint PT18 increases. Particularly, when the UR intersection point PT17 is fixed, the DLO uppermost endpoint PT18 is pushed backward such that the position of the rear header point RH is pushed backward behind the headliner by the same distance in comparison thereto. Consequently, the rear header point RH may be formed at a point of 600 nm from a hip point of a backseat to an X-axis distance B to be exempted from a test point or may be formed in a planar section of a rear header S to secure a jaw rotation space so as to reduce injuries of the occupant.

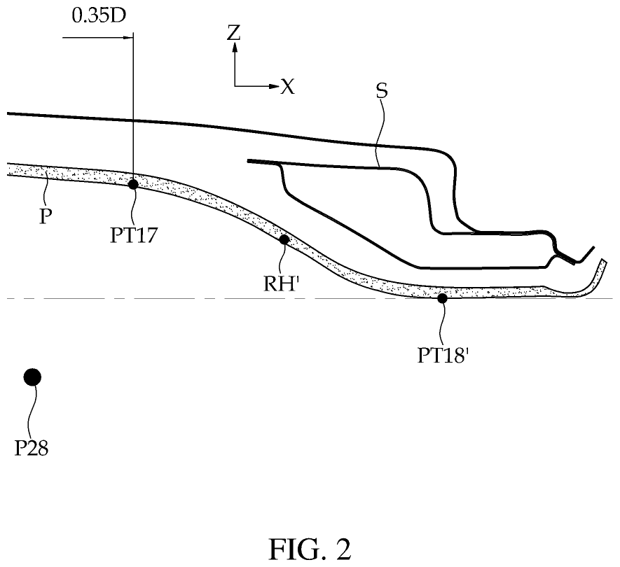

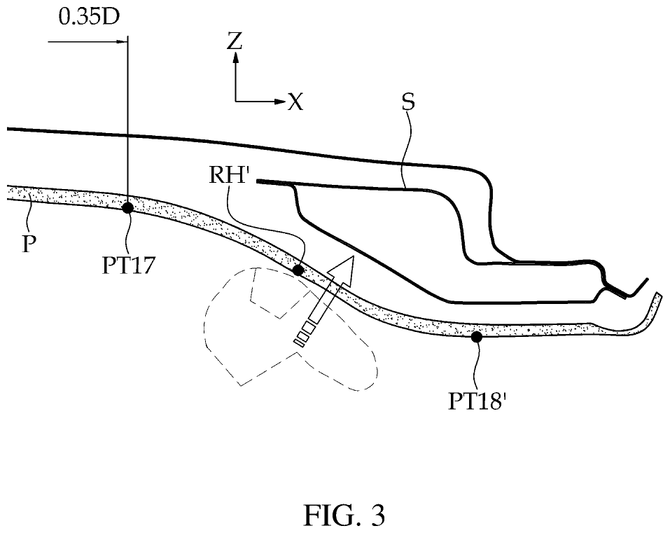

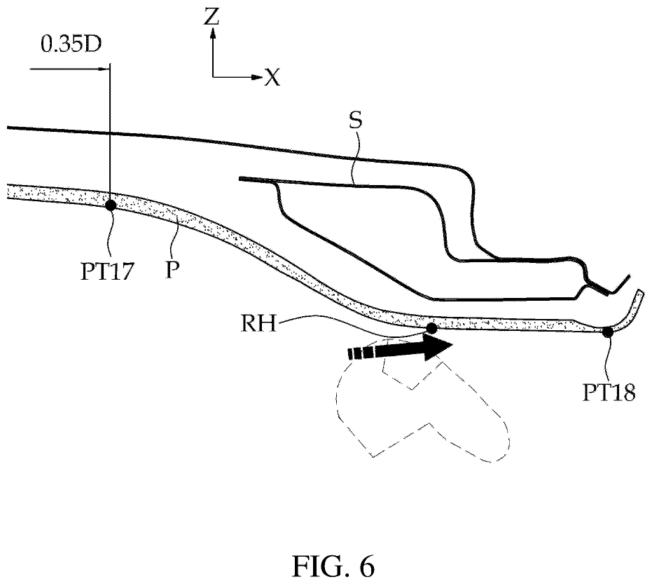

That is, in an existing headliner, as shown in FIGS. 2 and 3, a setting position is fixed such that a UR intersection point PT17 is located at a predetermined distance (0.35 L) from a rear edge behind a reference point M of a headliner plane P. Also, a DLO uppermost endpoint PT18′ is set at a point moved inward from the rear edge of the headliner plane P. Accordingly, a length between the UR intersection point PT17 and the DLO uppermost endpoint PT18′ is shorter than a length between the UR intersection point PT17 and the DLO uppermost endpoint PT18 according to the present invention in FIGS. 5 and 6.

Consequently, the existing rear header point RH′ which is a middle position between the UP intersection point PT17 and the DLO uppermost endpoint PT18′ is closer to the UR intersection point PT17 in comparison to the position of the rear header point RH according to the present invention. Accordingly, in the existing headliner, as shown an arrow in FIG. 3, when a head part of an occupant sit in a backseat applies a shock to the headliner, the head part applies a shock to an inclined plane of a rear header S so as to be seriously injured. However, in the headliner according to one embodiment of the present invention, as shown in FIG. 6, the rear header point RH is formed in a lower planar section of the rear header S such that the jaw rotation space may be secured so as to reduce a level of an injury.

Meanwhile, in an exemplary embodiment of the present invention, when a distance to the DLO uppermost endpoint PT18 measured along the headliner plane P is 112 mm or more, a point 112 mm from the DLO uppermost endpoint PT18 may be set as the rear header point RH. This is because when the measured distance is greater than or equal to 112 mm, the distance between the UR intersection point PT17 and the rear header point RH decreases such that it is impossible to secure an adequate space for the jaw to be rotatable when the occupant's head part tilts toward the headliner.

Also, in an exemplary embodiment of the present invention, as shown in FIG. 5, the rear header point RH may be set such that an angle θ formed by the XY-plane passing the above-described DLO uppermost endpoint PT18 and the rear header point RH is in a range of 0.5 to 10° or a height difference H between the DLO uppermost endpoint PT18 and the rear header point RH is to be in a range of 1 to 10 mm This is to secure a space, in which the head part is movable simultaneously to allow the head part to be movable along the headliner plane P when a car accident occurs.

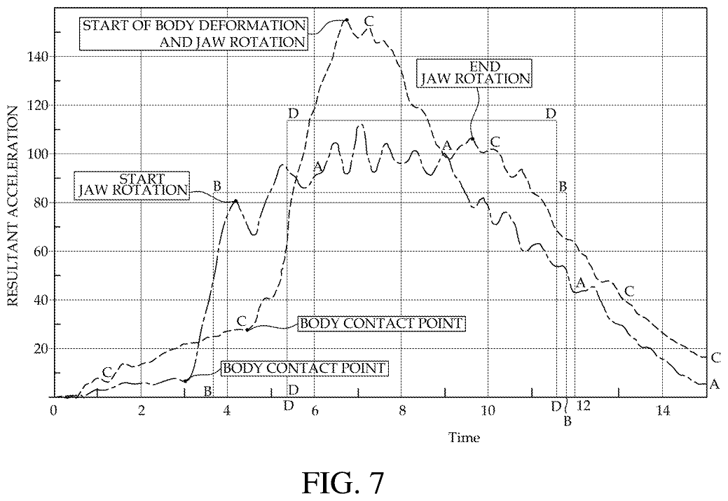

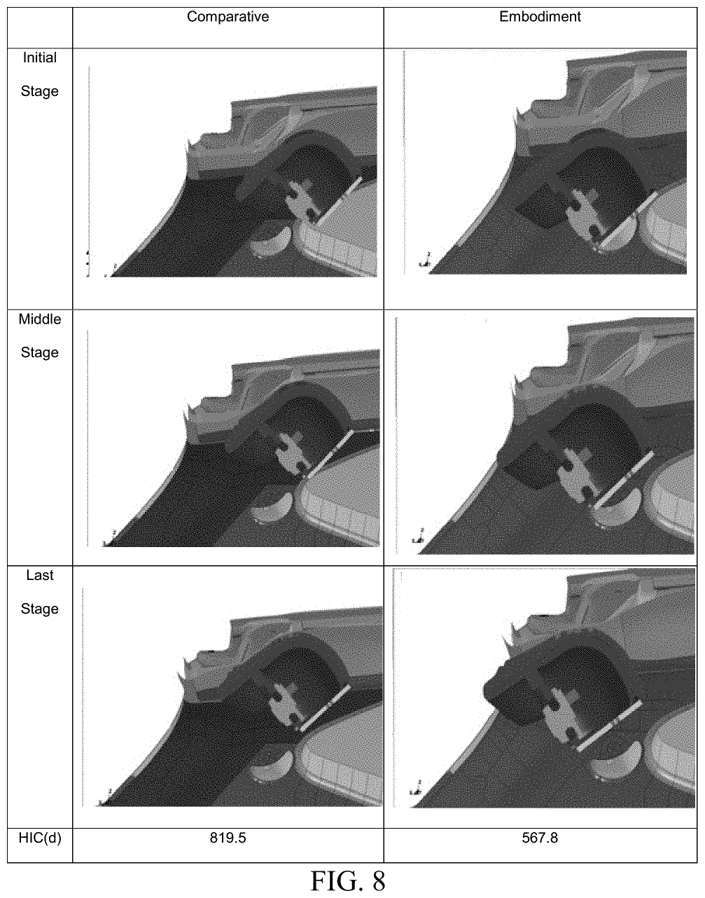

A result of measuring resultant deceleration according to a time change with respect to a comparison between a headliner for a vehicle (embodiment) in which a position of a DLO uppermost endpoint is moved to a rear edge part of a headliner plane according to the present invention with an existing headliner for a vehicle (comparative example) in which a DLO uppermost endpoint is not moved, is shown in the following FIGS. 7 and 8. In FIG. 7, a horizontal axis indicates time, a longitudinal axis indicates resultant acceleration, a dot-and-dash line indicates an embodiment, and a dotted line indicates a comparative example. A resultant acceleration graph herein is obtained according to FMVSS201U in which a head injury criterion (HIC(d)) is measured by measuring acceleration of launching a head-shaped dummy toward a headliner at a speed of 24 km/h.

As a result, as shown in FIG. 7 and FIG. 8, in the comparative example, the dummy comes into close contact with the headliner and applies a shock from the initial stage and a stronger shock is applied to the headliner as time goes on toward the middle stage and the last stage. On the other hand, it may be seen that in the embodiment, since an adequate jaw rotation space is secured, the headliner is initially shocked and then the jaw rotates at the moment of coming into contact with a car body panel such that a level of injury decreases.

This may be easily seen through the graph of FIG. 7. That is, in the comparative example, it may be seen that a point in time when a body comes into contact is slightly delayed but body deformation and resultant acceleration rapidly increases when the jaw rotates and a point in time when the jaw stops rotating is also increased. On the other hand, in the embodiment, it may be seen that a point in time when a body comes into contact is slightly early but resultant acceleration is low and there is little change in resultant acceleration from the start of rotation of the jaw to the end of rotation of the jaw. As a result, it may be seen that the HIC(d) of the comparative example is 819.5 and satisfies ≤1,000 but the HIC(d) of the embodiment is 567.8 and lower than that of the comparative example.

According to one embodiment of the present invention, a headliner for a vehicle, which is capable of reducing a head injury of an occupant of a backseat, provides effects as follows.

1. When a middle point between a UR intersection point PT17 and a DLO uppermost endpoint PT18 is set as a rear header point RH, the DLO uppermost endpoint PT18 is moved to a rear edge of the headliner instead of the UR intersection point PT17 which is a predetermined and unchangeable point such that the rear header point RH is moved to be behind the headliner and a space in which a jaw is rotatable when a head part collides with the headliner is secured so as to reduce a head injury.

2. Here, since the headliner is manufactured such that the rear header point RH and an XY-plane passing the DLO uppermost endpoint PT18 form a certain angle or have a height difference therebetween, the rear header point RH may be set at an intended position and the jaw may rotate in a certain jaw rotation space so as to reduce a head injury.

3. Also, when a distance between the DLO uppermost endpoint PT18 and the UR intersection point PT17 along a headliner plane P is greater than or equal to 112 mm, the rear header point RH is set as a point 112 mm from the DLO uppermost endpoint PT18 such that the rear header point RH may not be moved forward from the rear edge of the headliner by a distance greater than or equal to 112 mm so as to reduce a head injury.

4. Also, when the rear header point RH is far greater than or equal to 600 mm from a point P28 which is a hip point SgRP of the backseat in an X-axis direction, the rear header point RH is exempted from being a test target.

What is claimed is:

1. A headliner for a vehicle that is capable of reducing a head injury of an occupant of a backseat, wherein a proceeding direction of the vehicle is set as an X-axis direction, a width direction of the vehicle is set as a Y-axis direction, and a height direction of the vehicle is set as a Z-axis direction,
wherein a hip point that is a reference point of the backseat is set as P28, an upper roof intersection point intersecting a divisional line dividing an upper roof in a headliner plane cut by an XZ-plane passing the hip point is set as PT17, a rear edge part of the headliner plane is set as PT18 which is a daylight opening uppermost endpoint, a central point of a length which connects the upper roof intersection point and the daylight opening uppermost endpoint PT18 in the headliner plane is set as a rear header point, and the rear header point is set as a point 112 mm from the daylight opening uppermost endpoint PT18 when a distance between the daylight opening uppermost endpoint PT18 and the rear header point is greater than or equal to 112 mm, and
wherein an angle (θ) between an XY-plane passing the daylight uppermost endpoint PT18 and the rear header point is in a range of 0.5 to 10° or a height difference on the basis of the XY-plane is in a range of 1 to 10 mm in a Z-axis direction.
